(19) United States
(12) Patent Application Publication
(10) Pub. No.: US 2002/0087416 A1
(43) Pub. Date: Jul. 4, 2002

(54) System and method for providing learning material

(76) Inventor: Roger C. Knutson, Indianapolis, IN (US)

Correspondence Address: Bruce J. Bowman, Maginot, Addison & Moore, Bank One Center/Tower, 111 Monument Circle, Suite 3000, Indianapolis, IN, 46204-5115, US

(21) Appl. No.: 09/970,291

(22) Filed: Oct. 3, 2001

Related U.S. Application Data
(63) Continuation of application No. 09/557,109, filed on Apr. 24, 2000, now abandoned.

(51) Int. Cl. G06F 17/60

(52) U.S. Cl. 705/23

(57) ABSTRACT

A system for providing content such as educational, informational, or learning content that is obtained from the Internet and disseminated via the Internet to a user. The content is culled from the vast amount of content accessible via the Internet according to various user profiles. The content may be filtered and formatted as appropriate for the user according to the various user profiles. Content may be gathered and disseminated in response to a predetermined learning plan, or on the fly via a user configurable GUI. The content may also be coordinated and indexed to each users profile. A profile is interactively developed from the individual, stored in a relational database, and continuously updated from an individual's learning results. The educational material is converted into contemporary, multi-tiered object oriented content utilizing Internet browser technology (i.e. HTML, VRML, HTTP/IIOP, Visual Basic, Active X, XML, RDF, Java-script, etc.) and integrated to the presentation level (provided to the user) using object oriented technology and standards (e.g. OODBMS, Java, SQL, Oracle, CORBA, OLE, COM, etc.). Content may be provided by third parties, in addition to the free content on the Internet, on a fee basis. The content is linked to the various profiles, while the object-oriented fabric serves to provide the filtered and formatted content to the user as appropriate.

The present application is a continuation of and claims the benefit of co-pending patent application Ser. No. 09/557,109 filed Apr. 24, 2000 entitled Education System and Implementation.

### BACKGROUND OF THE INVENTION

1. Field of the Invention

The present invention relates to education and educational systems and methods and, more particularly, to computer assisted education and educational systems and methods.

2. Description of the Related Art

Various methods of teaching have been proposed and/or implemented over the years. Beginning in the early 1960's an educator, Fred Glancy, Jr. took many of the components in education that were successful, along with research from around the world, and assembled a new program for public education. The program was given local, state and international awards and was named the Glancy Educational Method (GEM). Some of the developments in GEM that started this movement included recognition of varied learning styles, learning disabilities, computerized Individual Learning Plans (ILP), computerized Individualized Educational Plans (IEP), mainstreaming of all special education students into a traditional school system, and the application of a computerized learning template with educational methods to teach according to the template.

The philosophy behind GEM is that every human being is comprised of a unique blend of learning/developmental abilities and limitations. Each person learns, develops and grows differently as each person is a composite of learning abilities drawn from the basic motor, visual, language concepts and auditory characteristics and experiences of their world. A person's learning pattern is made up of a physical, emotional, environmental, sensory, genetic, spiritual and developmental set of interrelated attributes. Each person or student thus has his or her own unique attributes based on the various experiences and characteristics noted above that essentially defines the individual and his or her learning characteristics.

When a student's learning characteristics are understood, a style or manner of instruction that best fits the student's mechanism of learning can be ascertained and applied in any environment. When we know and teach each person as an individual in accordance with the person's learning characteristics, we then begin to shape more efficiently the operations of teaching and administration. The GEM thesis for all education applies this concept to adapt a separate teaching style that reaches each person individually in accordance with that person's learning characteristics. When we can accomplish that goal, it follows that true learning takes place. Some proven advantages to this approach include teacher fulfillment, parent satisfaction, and administrative efficiency.

Under GEM, individualizing the learning process yields a continuing positive educational experience for the student and the teacher. This can occur without special teacher training, without slighting the needs or expectations of any child in the classroom, and without long, extra hours of preparation. The highlights of GEM include: a) teaching each student as an individual and a whole human being; b) labeling no child as retarded, deaf, blind, etc., as each person would be taught through the way they learn; c) screening and individualizing instruction for all students in or out of the regular classroom; d) providing precise information, materials, and systematic recording procedures; e) backing up each teacher with information and resource support necessary for individualizing instruction without significant additional teacher training; and f) doing all of these without demanding excessive preparation time out of the classroom. The above GEM goals and attributes were met and implemented with technology existing at the time of development, namely hand-written or oral teacher to student teaching and evaluating/testing with the aid of books, manuals, and other paper-based materials. Since GEM was developed in the 1960's albeit refined in the 1970's, it does not take advantage of present computer technology both as to its enhancement and implementation. With the advances of technology and voluminous addition of information constantly streaming into our lives, and the need for students to understand, assimilate, and/or learn the vast amount of material, there is a need for an update of GEM in accordance with present technology.

A learning management system for use by microcomputers was marketed in 1987 by Insight Unlimited, Inc. of 350 Sagamore Parkway, West Lafayette, Ind. 47906. The Insight Learning Management System (ILMS) is menu-driven or command-driven software that tests a student's learning abilities and creates a user profile based thereon to present information from a database of activities/lessons, tests and remediations. Customizable reports may be generated to track a student's progress. Individualized education and learning plans are formulated by the software. The database/software also has import and export capabilities.

One learning system that utilizes computers is U.S. Pat. 5,813,863 issued to Sloane, et. al on Sep. 29, 1998 entitled “Interactive Behavior Modification System,” wherein there is described a Multimedia Behavior Modification System (MBMS) that utilizes computers for presenting or teaching the material. The MBMS includes courseware for a particular topic and delivers the courseware over a local area network (LAN), wide area network (WAN), or the internet. The coursework includes a selectable progression of modules including dynamic introductory modules leading to a combination of education modules. User selectable links to primary learning modules is provided in a menu. A tracking module tracks user decisions and other characteristics and alters the program content accordingly.

Another learning system is described in U.S. Pat. 5,810,605 and 5,904,485 issued to Siefert on Sep. 22,1998 entitled “Computerized Repositories Applied to Education,” and on May 18,1999 entitled “Automated Lesson Selection and Examination in Computer-Assisted Education” respectively. These related patents disclose a system for computer assisted education in which a school curriculum is stored in computer repositories. A learning profile is maintained for every student which indicates the capabilities, preferred learning style, and progress of the student. Based on the profile, the program selects proper lessons, administers examinations, updates the profile, and links the student with a subject matter expert when necessary. The system also establishes a video conference between the student and faculty member or other individual when necessary.

While the above systems utilize computers that may be networked to meet learning/educational needs and specifically the two above-identified Siefert patents disclose the use of learning profiles to select computer stored lessons for a student based on the student's profile, they are deficient in flexibility and dynamic use of current technology.

What is therefore needed is a system and/or method that utilizes current technology to provide educational material.

What is further needed is a system and/or method that utilizes the technology of the Internet and related tools to provide educational material.

What is further needed is a system and/or method that provides tailored information to a user that is obtained from existing information gathered from the Internet.

What is yet further needed is a system and/or method that provides tailored and filtered educational material to a learner that is obtained from existing information gathered from the Internet in a style and platform to accommodate the learner.

### SUMMARY OF THE INVENTION

The subject invention, in one form, is an Internet based education, information, and/or learning system and method that matches Internet content with an individual's learning preference and/or position in a learning chain. Content, encompassing educational, informational and learning content, is retrieved from existing Internet content. The content is based on a user's personal and/or learning profile. The system filters the content appropriately based on the user's profile(s). The content may also be filtered according to the user's educational plan, learning rank, testing results, level in a learning chain, and/or otherwise.

In another form, the subject invention is an Internet based learning system in which existing content is gathered from the Internet, filtered to obtain learning content, and provided to a user in accordance with a particular teaching methodology such as the GEM methodology. The learning content may be reformatted for near-universal use by web-enabled devices or be user-hardware specific. Additionally, the learning content may be (re)formatted appropriately in accordance with the user's learning profile.

A central system in communication with the Internet provides a platform that gathers content from existing content on the Internet, filters the gathered content appropriately, classifies the filtered educational content, reformats the educational content appropriately if necessary (i.e. in accordance with a user's profile). Reformatting preferably utilizes a user-specific hardware profile methodology and/or a user-specific profile methodology. The central system is built with object-oriented technology. Particularly, the central system consists of an object model. The various portions of the object model provide parameters for the various functions of the system. The content is preferably stored in an object-oriented manner in accordance and in conjunction with the object model. The object model is utilized to provide the appropriate content to a user in accordance with the user's learning profile and/or level with a learning chain of a learning plan, along with a user's hardware profile.

In one form, the above is implemented utilizing the latest computer/Internet technology coupled with the GEM prototype program. An education plan is developed for each student. The educational plan includes, but is not limited to, a user profile, a hardware profile, and a testing profile. A template or palette will be developed from the various profiles that determine how each user learns and how to present the educational content to the user. Contemporary, multi-tiered, Internet browser technology (e.g. HTML, VRML, HTTP/IIOP, Visual Basic, Active X, Java-script, etc.) is integrated to a user presentation level using object oriented modeling and standards (e.g. OODBMS, Java, XML, RDF, CORBA, OLE, COM, API, etc.) coupled with relational databases (e.g. SQL, Oracle) to reach every web-enabled device (user) on the Internet.

From the individual perspective, a learning template will be interactively developed preferably via a proven set of GEM testing and remediations. The learning template will also be continuously and dynamically updated based on factors such as performance (testing) on previous lessons/educational material. This specialized template is then correlated to a learning style and an appropriate philosophy is used for instruction. The primary hardware tool is the personal computer or Internet capable networked device, which will provide the medium for continued training. The educational content is provided in an appropriate format to the Internet capable device in accordance with the hardware profile. With existing technology and planned future developments, an object-oriented and/or relational database routs activities to satisfy the educational needs for each template linked to every concept in education, industry, work force, social skills, and the like.

In one form, the educational material is culled or gathered from the vast ocean of information and/or content already available on the Internet. This Internet information or content would be filtered, evaluated and/or indexed to become educational material or content, and then linked to template or profile characteristics. The object-oriented fabric of the system then serves to push the educational and/or informational content and learning style to the user based on the template. An intelligent software program serving as a programmable agent may act as a filter and coordinator of information tailored for individual use (i.e. via the template) while GEM program specifics may be used to assemble the information/data for the user/student.

The template or palette will be determined by identifying the potential strengths and needs of each individual to produce a total learning template or palette. It is well known that realistic expectations enhance learning; improving interpretation of needs, creating a healthier emotional atmosphere, better parent/teacher/student understanding, communication and a stronger educational climate. These are some of the rewards of this essential effort. It is critical to identify “uniqueness” in the individual. The present invention advocates a close, continuous “look” at the student and a curriculum with limitless computer assisted learning activities built upon that resulting template. As well, the present invention captures the picture of the total individual rather than only one aspect of learning. This picture results, in a coordinated, multifaceted interpretation of potential, and is then shared with all those who would be incorporating this interpretation into a developmental template for assisting the person in living in and learning about the environment. In this manner resources are brought to the individual, not the other way around.

Proper profiling of learning ability to produce the template or palette is accomplished through examination of motor processing, auditory processing, visual processing, language, and basic concept development, physical, emotional, environmental, sensory, and spiritual cognitive development. Template or palette identification through genetic evaluation and/or sensing of human neuro-biological indicators (bio-factors) may also be used as input to a profile. By analyzing this developmental set of interrelated attributes, learning strengths and preferences can be identified. The collected data (template composite) serves as a reference for measuring educational growth for each individual. As an example, a template may be compiled through the following steps:

First—Use the GEM testing format to build a template for each student on how he/she learns and functions. This template will be stored relationally in a database. Most material and testing will be done via the computer. A minimum number of test items will be administered separately and entered manually into the computer. The template will be changing as the student evolves. Most of this material can be taken directly from the existing documentation.

Second—An automated computer retrieval/database system will provide students and/or teachers/parents activities for students to learn a concept based on the developed template. The database of learning activities is compiled from both existing Internet resources and contributed material that will be continuously expanded and/or updated. Instructional Examples (“IEs”) may be added in the database to those that have already been found to be effective by any contributing agent upon the payment of a fee to the database owner. Before adding any IE, they will be screened through a selected team of individuals or an individual knowledgeable in each category and subject area of education, or via an automated version by modules of artificial intelligence. The IE's selected for a given concept will be based upon various evaluation criteria preferably according to GEM principles. Each IE will be coded or indexed to certain types of learners according to their template. Some may even be used for all types of learners. The traditional Learning Chain will be evolutionarily enhanced over time. Parents, students, educators, etc. will also provide IE's and they will be channeled to the right teams. The IE's produced will be used in many ways: for example, virtual reality, for the tactile and kinesthetic learner; voice for the auditory, videos, for demonstration, and printed word for the visual. The IE's will be gathered, developed, coded, stored, and retrieved via the object-oriented database (OODB) management tools for every learning concept in education. Commercial educational software providers can supply programs that can be certified and templated on a fee basis. The database of IE's will be added to or deleted as better methods are developed. As new concepts are added to education, new IE's for each template will be developed, screened, selected and added. The world's best educational examples will be available to every individual. A level playing field for all people regardless of race, physical impairment, ethnic background, etc. to progress through the Learning Chain.

Third—The majority of the concepts and communication will be accomplished via a web-enabled computing or processing device (WEC). Based upon an individual template, the system will present a concept accordingly through appropriate education content that has been formatted accordingly. Educational content will be selected according to the student's total template, level of development, and position within a learning chain of the educational plan. This is done under supervision of the educator.

Fourth—The home WEC can be used for projects or lessons away from a classroom. Each individual will have a unique identity (i.e. social security number and password), and will work select activities or be provided select educational content according to individual template for learning, and correlated to the concept on which they are working. Parents may also “log on” and bring up activities they can present to the younger student.

Fifth—A complete tracking system will handle all records, achievements, template updates, etc. to gauge the success of the program. This same information is available to the individual to assess achievement.

In accordance with another aspect of the present invention, an overseer is provided with a correlative program of products and services through the Internet and related technology. Parental awareness of the child/student as a member of the family should correspond with his or her needs and the specific individually prepared program. This process makes it possible for the first time to teach each child at his/her own intellectual and motivational level, utilizing the easiest mode of learning and advancement, in an individual or conventional group setting. The facility of this process promotes teacher compliance and makes it readily usable by parents and students as well.

In accordance with another aspect of the present invention, work will be performed with individuals of varying degrees of intelligence and ability. It includes all classifications of special education. The unique evolutionary design adjusts automatically to different demographic characteristics and is accessible across all lines of gender, race, national origin, disability, age, etc. It is considered to be culture-free.

At the heart of this process is the individual learning palette comprised of hundreds of elemental rungs, built from sensory, perceptual, and motor interplay, which are interwoven and then translated into their corresponding behavioral, academic, and coordination states. These areas of physical and cognitive endeavor, in turn embrace another magnitude of evaluative strategies, physical-medical treatments, therapeutic techniques, and educational remediations.

The benefits of this implementation cannot be fully fathomed at this point, however; some of the immediate advantages are intuitively obvious:

The cost of education could be drastically reduced;

Potential realization of world wide education tailored to the students learning template;

Students can progress at their own rate and pursue studies on their own;

Individuals can learn in depth areas of interest outside of the classroom;

Student and administration workload would be greatly minimized;

Underprivileged or ethnically diverse students will have templates and educational remediations tailored to their unique learning style;

The opportunity for parent and teacher enhancement of the overall teaching process;

More communication and understanding;

Consistent education on contemporary problems like drugs, gangs, weapons, criminal justice, population growth, etc.;

A real time understanding of the user's template and educational level;

Students will be able to continue the educational process year around and at any time or place, to provide better association with their family and social setting;

Interaction among students can now become much greater than just the immediate classroom. They can be linked on a global basis and understand their intellectual position from a global standpoint;

Using this medium and this level of interaction to make the educational process stimulating can reduce time now spent watching non-educational television programs. Contemporary TV will merge with Internet capabilities to facilitate expanding video, interactive, and virtual reality tools;

Continuing education and retraining programs can use this technology efficiently and economically;

Adult education and on the job training;

Military training can be upgraded and made more efficient;

Better teacher morale since: 1) Their time is freed to teach; 2) They no longer have to spend hours planning screening tests, developing teaching plans, formalizing parent—relation programs, making reports, detailing accountability; 3) Teacher confidence is strengthened since they know what to do with the students. They have definite plans and parent action coordinated with the support of the school; 4) The total program is organized, prepared and provided for them with some of their own input or changes; 5) It also helps provide more effective teaching methodologies for the entire classroom as well as individual; and 6) They get written, fully detailed “what, when, how, who, why” information through the present invention known as MindshareTm or the Mindshare Solution™.

Less disruptive behavior with happier children since: 1) The programs they enter are equal and of the best quality; 2) Their frustrations are being alleviated; and 3) their total personal needs are being given prime consideration;

Better parent cooperation/school relations since: 1) Parents know what is going on; 2) They are fully informed “why, how, when” and “what is in progress”; 3) They are formally recognized, conferred with and shown how to share in the action plans including at-home activity programs; 4) Parents get their own Mindshare™ program to follow—coordinated with the school program; and 5) The family also is drawn closer together through better provision of intra-family understanding/stability/goaling focused on the strengths and needs of the student.

Improved educational environment since: 1) Each school-staff member's role is clarified and included in the program; 2) All are working together on an agreed upon plan; and 3) All are working toward one explicitly stated goal . . . to help the student.

Assured accountability for the teacher since: 1) They have selected a comprehensive, soundly professional method and program (GEM), that is internationally recognized for effectiveness; 2) Their implementation of the method and program is verified by programmed action plans; 3) Enhancement of community awareness/cooperation through accountability to the School Board; 4) Efficiency in relationships with community professional and trade associations; and 5) Effectiveness in interfacing with the social providers of the community.

In yet another form, the subject invention is a web based, enterprise-wide, knowledge management system, apparatus and method (collectively, “application”), that uses a semantic engine to mine or gather relevant information from a variety of sources, especially that of the Internet. The application delivers the mined content in a format that users can refine and annotate. Supporting both individual users and communities of interest, the application archives valuable content, such as queries, returned documents, and refined documents, for future access.

The application is built on a semantic engine and a user-editable GUI. The semantic engine supports searches and organizes post-search processing. The subject application enables advances in linguistic processing through a user editable generic English lexicon and other tools that assist in clarifying meaning. Also, the user can augment the lexicon with user-defined concepts.

The semantic engine analyzes an area or areas of interest for key concepts and then presents the user with a range of answers for each concept. The user refines the area of interest by selecting the best answer and weighing each concept's importance in relation to other concepts. The application then translates the interest into a complex Boolean query suitable for a variety of search engines. It enhances the query by supplementing key concepts from the user defined preferences and palette information during the translation process.

Search engines, such as Alta Vista, typically search a document's metadata (document title, source, date, summary sentences, and other fields) to determine if the document matches the search criteria. The subject application can work with several search engines at the same time to provide enhanced queries. The enhanced queries increase the effectiveness of the search engine's retrieval activity. Once returned, all search engine results are then refined.

The application sets a relevancy threshold for returned documents using a mathematical algorithm. The algorithm, designed to analyze the sequence of thoughts in a document, determines if those thoughts are relevant to the user's palette. The algorithm operates paragraph by paragraph in a document, looking for the paragraph with the most relevant thought and delivery mechanism. Based on the user's input, a combination of concept weighing and desired relevancy percentile ranks the paragraphs. Periodically users are asked to baseline and test the validity of the palette information. For example, in this mode of operation, users assign one of three weights to each concept: key, regular, or ignore. A key concept weighs twice that of a regular concept. An ignore concept has a weight of zero. Ignore concepts prevent the subject application from spending computation resources on conjunctions, prepositions and other extraneous parts of speech. The user then selects the desired relevancy level (percentile range between 0 and 100) that a response must meet to be categorized. To calculate relevancy, the subject application locates the most relevant paragraph in the document and calculates its weight. A 50% relevancy level means that the most relevant paragraph in the document must contain at least 50% of the responses total possible weight. Should the document's most relevant paragraph contain all of the possible concepts, the subject application further analyzes the paragraph by order of concepts in the paragraph versus order of concepts in the interest.

The subject application post-search activity saves users significant time by focusing the user's attention to only those paragraphs in a document or documents that are considered relevant. Duplicate documents and documents with content that did not meet the use-specified relevancy threshold are deleted. The subject application's semantic engine identifies and hyperlinks key concepts in the remaining documents. The user then quickly navigates through selected paragraphs that contain key concepts. A document is then analyzed with all of the user's active interests each time that document is opened, including documents saved to a user or group repository. Thus, the unexpected correlation of different concepts found in the same document gathers new knowledge.

The user can save the original document, not just the relevant paragraphs. Dragging and dropping saves documents metadata (source, date, author, and other user defined fields) within the GUI. The user can annotate any object (documents, folders, and metadata) in the repository with pertinent information that makes the document useful not only the user, but which also updates the palette information for future comparison searches.

Saving and linking exceptionally useful documents and folders to appropriate concepts keeps the palette current with use of discipline-specific vocabulary. It also indexes reference work for use by others via palette mapping to the enterprise. This enterprise memory is a permanent record of lessons learned, accessible to any individual using the system.

The subject application is a state-of-the-art, java-based client/server architecture and includes a set of commercially available enterprise applications. Java provides an operating environment that is easily deployed in a variety of server workstation configurations and across the Internet. Computationally intensive tasks are placed on the server. The workstation hosts a “thin client” that manages the user interface. Users can connect to the application with Internet accessible workstations that have the application client installed to access their repository at work, from home, and during travel. A user's repository opens in the state the user last left it, no matter where or when the user logs into the system. This virtual educator allows users to work on a project at times and places that match their personal schedule. The virtual teacher also keeps users in contact with information that matches their educational level and/or user information preferences retained as palette characteristics.

The subject system utilizes an enterprise relational database management system (RDBMS) for content storage. A document management system to store non-hypertext markup language formatted content is supported. Additionally, third-party tools can, as necessary, access content for additional analysis and process.

Further, the subject system interoperates in today's enterprise information technology (IT) environments. These environments typically are collections of disparate data sources from personal systems (e.g., Microsoft Access), legacy databases, and current RDBMS. The subject system works with all these sources through application programming interfaces and search engines to access data without disrupting normal operation, and requires minimal IT support. Users manage most of the operational configuration through administrative components. The system identifies the users client capabilities for processing and display and provides data to meet those parameters. It is capable of presentation in the “thinnest” client mode of HTML for inexpensive interaction. The subject application will also take advantage and recognize fuller function clients for instruction via video, audio, sensory/feedback, etc.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a representational block diagram of the subject system and method;

FIG. 2 is a representational diagram of the computing infrastructure of the subject system;

FIG. 3 is a representational diagram of the framework logic of the subject system;

FIG. 4 is an exemplary program interface for the subject system;

FIG. 5 is a block diagram of an exemplary system in accordance with the principles of the subject invention;

FIG. 6 is a flow-chart of an exemplary manner of operation of the subject invention;

FIG. 7 is a diagram of an exemplary embodiment of the subject system utilizing J2EE application servers;

FIG. 8 is a diagram of an exemplary architecture of a portion of the system of FIG. 7;

FIG. 9 is a diagram of a portion of system flow or a manner of operation of the subject system of FIG. 7 in accordance with the principles of the subject invention;

FIG. 10 is a diagram of a further portion of system flow or a manner of operation of the subject system of FIG. 7 in accordance with the principles of the subject invention;

FIG. 11 is a diagram of a further portion of system flow or a manner of operation of the subject system of FIG. 7 in accordance with the principles of the subject invention;

FIG. 12 is a diagram of a further portion of system flow or a manner of operation of the subject system of FIG. 7 in accordance with the principles of the subject invention;

FIG. 13 is a diagram of a further portion of system flow or a manner of operation of the subject system of FIG. 7 in accordance with the principles of the subject invention;

FIG. 14 is a diagram of a further portion of system flow or a manner of operation of the subject system of FIG. 7 in accordance with the principles of the subject invention;

FIG. 15 is a diagram of a further portion of system flow or a manner of operation of the subject system of FIG. 7 in accordance with the principles of the subject invention; and

FIG. 16 is a diagram of a further portion of system flow or a manner of operation of the subject system of FIG. 7 in accordance with the principles of the subject invention.

Corresponding reference characters indicate corresponding parts throughout the several views.

### DETAILED DESCRIPTION OF THE INVENTION

As used herein:

The term GEM stands for Glancy Educational Method. GEM is an existing approach of student evaluation for the purpose of tailoring educational content to the individuals PALETTE to maximize cognitive assimilation.

The term PALETTE stands for Psychogenetic and Audiometric Learning Template, Tailored Evolutionarily. The word template is generally synonymous with PALETTE.

The term Learning Chain is the known logical progression of skills required to master a given subject (e.g. a student will learn geometry, trigonometry and calculus in a prescribed order).

The term ebot is a software agent/program that is deployed to perform tasks on the Internet without direct guidance. Ebots perpetually navigate the Internet performing complex tasks such as abstraction, encapsulation, modularity, reusability, concurrency and distributed operations. In the framework of the present Mindshare™ system, an ebot is used to categorize Internet content into palette friendly knowledge gems. This knowledge agent or Knowbot will automatically gather information and map it into the optimum palette format. The knowbot may evolve to a trillion neuron entities, automatically learning about and discovering new ways to perform its function better.

The term educational portal is an interface into a vast amount of information that has been tailored to meet the specific learning style and capability of the student. The user interface is evolutionarily adapted to meet the individual palette.

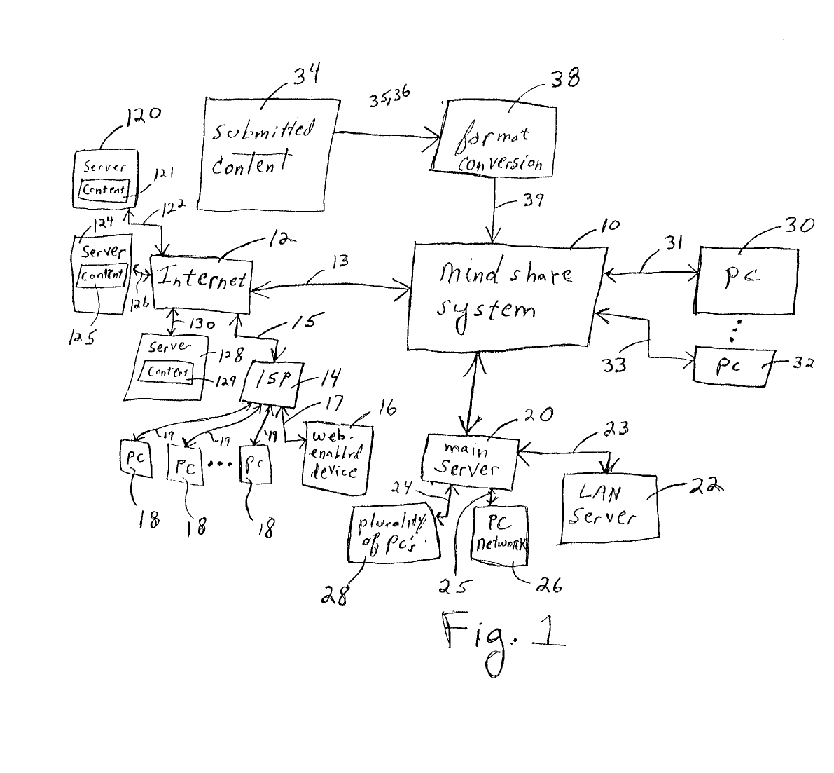

Referring now to FIG. 1, there is depicted an exemplary representation (e.g. block diagram) of an embodiment of the subject invention in accordance with principles presented herein. A server/database/system 10 as is known in the art represents the Mindshare™ System/Program (hereinafter “system”) is a single logical system and database. The system 10 may be many systems networked to one another rather than a single system. The system 10 contains or stores various learning materials, programs, tests, etc. (collectively termed educational or learning material) at least most of which is preferably correlated with one another. In one form, the educational material includes, but is not limited to, the GEM material. The educational material consists of still pictures or frames, video clips, audio clips, and/or any other type of multi-media formatted information/data. Such educational material may be formulated into lesson plans, connected learning modules, etc. or any other assemblage of information/data that is deemed to constitute instructive content (IC).

As well, the educational material includes submitted content 34 that is forwarded to the system 10 by third parties who desire for the material to be included. The submitted content 34 may be forwarded via electronic means as signified by the bolt 35, or by other means as signified by the arrow 36. As with all educational material, the submitted IC is evaluated for suitable content, indexed, and linked to template characteristics. This object-oriented fabric of the system 10 then serves to push data (provide the material) and learning style to the individual based on the template. A program director (i.e. a group of individuals or a single individual) or a programmable/automatic agent (i.e. a computer program) acts as a filter and coordinator of educational material/information tailored for individual use while GEM program specifics will be used to assemble the information/data.

The submitted content 34 may need to undergo format conversion 38 before storage in the system 10. Such format conversion 38 may be scanning via a scanner (not shown) of a document or documents. Format conversion 38 may also be conversion from, for example, “JPEG” to “GIF” formats, or similar format conversion.

With submitted content 34, the originator and/or supplier could be charged a fee to consider and/or use the content within the context of the Mindshare™ Program. An ongoing fee for use of the submitted content (now educational material, assuming the same is approved for use by the program director/programming agent) could be calculated based on the number of times the educational material is accessed. Of course, other schemes for calculating fees for use may be used.

As well, the system 10 is connected to the Internet 12, as signified by the line 13, in order to obtain resource(s), material(s), and data (collectively “content”) available via the Internet 12. This is represented by the server 120, the server 124, and the server 128 (the servers 120, 124, and 128 thus representing all or the plurality of the servers or the like of the Internet 12, while the content 121, 125, and 129 represent all of the content of the Internet 12). The server 120 contains content 121 that is accessible to the system 10 via the connection 122 via the Internet 12. The server 124 has content 125 that is accessible to the system 10 via the connection 126 via the Internet 12. As well, the server 128 has content 129 that is accessible to the system 10 via the connection 130 via the Internet 12. The content 121 may be educational, learning, informational or the like and is obtained from the various servers by the system 10.

In accordance with an aspect of the subject invention, the system 10 gathers content from the various servers via the Internet 12. Particularly, the system 10 looks for specific content from the Internet 12 based on learning, educational, or informational need of a user. The template or palette of a user may be consulted to seek the particular content. The content is then gathered by the system 10 and then stored thereon. More particularly, the system 10 may utilize a semantic engine to seek and retrieve content that is appropriate for the particular user. The user may, according to an aspect of the subject invention, provide various queries for information via a graphical user interface (GUI). In another instance, a specific educational, learning, or information plan may seek and select the appropriate content from the Internet 12. In both cases, the user's palette is preferably utilized to correlate the gathered content to the specific user.

The palette may also provide management of the content sought, gathered or collected, and provided to the user. Since the content from the Internet 12 is typically in a “raw” form, the gathered content may need to be filtered before it can be provided to the user. The content may not be appropriate for a user for various reasons, such as age problems, learning progress or chain problems, or the like. Filtering may include editing the content so that it is suitable for the user in the various respects noted above, as well as for the information or learning content thereof. Further, the content may be evaluated for suitable content, indexed, and linked to template or profile characteristics. The program director or programmable agent would as well, review the content before making the same available as provided content. Since the content from the Internet 12 is free, there is no fee charged to an Internet (web),site for its use. A web site may, however, be charged for content use depending on the circumstances.

The educational material or content that is chosen, selected, or gathered in response to the system 10 needing to obtain content for providing learning or information to a user is processed by the system 10 according to the user's profile. The content may be stored on the system 10. The system 10 also formats, reformats, or converts the content in accordance with the user's profile and/or the user's hardware profile such that it is provided in a format or level that is appropriate to the user. This typically involves formatting into contemporary, multi-tiered, Internet browser technology using HTML, VRML, HTTP/IIOP, Visual Basic, Active X, Java-script, XML and the like. Further this may involve integrating the content to the presentation level using object oriented technology and standards such as OODBMS, Java, SQL, Oracle, CORBA, OLE, Websphere™, Metaphase™, and the like.

As depicted in FIG. 1, the presentation level material (content provided by the system 10 to the user) from the system 10 may be accessed by or via an Internet Service Provider (ISP) server 14 shown as in electronic communication with the server 10 via the internet 12 as indicated by the bolt 15. The system 10, of course, would have an Internet address such as “www.mindshare.edu”. A home personal computer (PC), workstation, or web-enabled device 16 (collectively “PC”) is electronically connectable to the ISP 14, as signified by a line 17, via any known means (e.g. modem, ISDN, cable modem, satellite, TI connection, or the like). As well, the PC 16 may be a custom “system” device. The PC or Web 16 preferably runs an Internet browser as is known in the art or a custom system platform. The PC 16 is thus adapted to receive content or educational material on the presentation level as described above through the system or Mindshare™ HTML/Java/XML/etc. program. As well, the PC 16 would be able to run the System GUI as explained below. The System GUI allows the user to formulate content requests that the system 10 would carry out in the same manner as the system 10 gathers and processes any content in accordance with the present principles.

A plurality of PCs as indicated by a second PC 18 is electronically connectable to the ISP 14, as signified by a line 19, via any known means (e.g. modem, ISDN, cable modem, TI connection, or the like). As well, the PC 18 may be a custom Mindshare™ device. The Web 18 preferably runs an Internet browser as in known in the art or a custom Mindshare™ platform. The PC 18 is thus adapted to receive content or educational material on the presentation level as described above. As well, the PC 18 is configured/adapted to run the System GUI.

There are other means to access the Mindshare™ system 10 as indicated by server 20 in semi-direct electronic communication (not via the Internet) with the Mindshare™ server 10 as indicated by the line 21 via any known means (e.g. modem, ISDN, cable modem, TI connection, or the like). Additionally, a remotely located LAN/WAN or other network server 22 may be in electronic communication with the server 20, as indicated by the line 23 via any known means (e.g. modem, ISDN, cable modem, TI connection, or the like). Representing a plurality of networked PC's are PC 26 and PC 28 coupled via network 24. This may represent a school, school system, business, or other network environment that can gain access to the Mindshare™ system 10 and use the Mindshare™ Program/System as described herein.

Further, additional PCs 30 and 32 may be directly coupled to the Mindshare™ system 10 via a network or individually. These PCs may all connect to and allow participation with the Mindshare™ system in accordance with the subject principles. Anyone who has access to such a web-enabled device may therefore gain access.

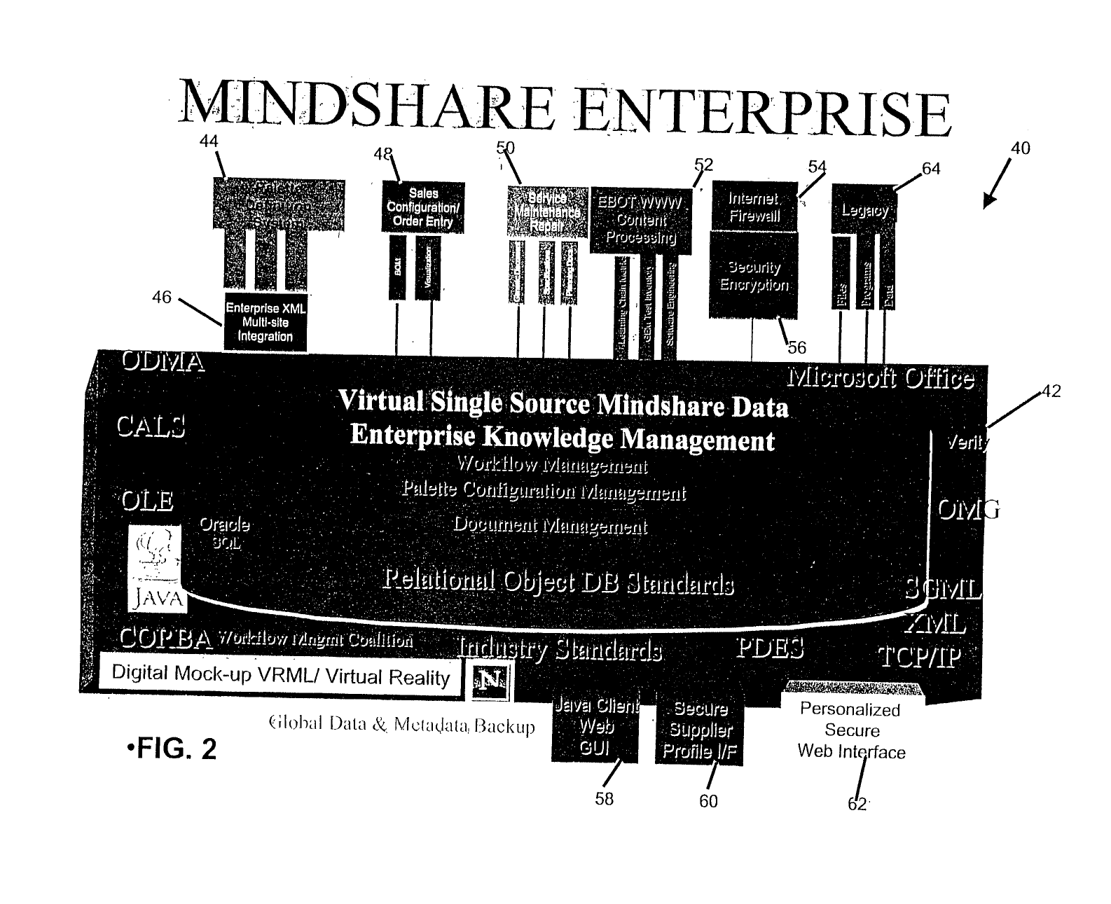

With reference to FIG. 2, there is shown the Mindshare™ system 10 computing infrastructure generally designated 40 that correlates, compiles, configures, oversees, implements, manages and/or controls the various aspects thereof. The computing infrastructure 40 includes a program management structure 42 that is tied together based on relational object database standards such as Oracle™ or SQL. Within the program management structure 42, workflow management, palette or profile configuration management and document management take place based on various operating environments indicated in the Figure.

The computing infrastructure 40 supports a palette or profile definition system 44 having configuration matching, configuration compatibility, and configuration options processing. The palette or profile definition system 44 is supported by an enterprise XMP multi-site integration 46 that ties the palette definition system 44 to the program management structure 42. The computing infrastructure 40 also includes a sales configuration/order entry 48 having BOM and visualization that is integrated with the program management structure 42. As well, service, maintenance and repair 50 also forms part of the computing infrastructure 40. Within the service, maintenance and repair 50 is generic documents, specifications, and planning documents.

The Mindshare™ computing infrastructure 40 also includes ebot world wide web (internet) content processing 52 for content located thereby. Such content processing includes learning chain metrics, GEM test inventory, and software engineering. As the ebot or knowbot navigates the Internet for gathering content, the content located must be processed for appropriate user and any other criteria in order to make the same available to the user via the various profiles. As well, since the present Mindshare™ System 10 is preferably applied through the Internet, the computing infrastructure 40 includes a firewall 54 with appropriate security encryption 56, as are generally known in the art. Additionally, the computing infrastructure 64 includes an appropriate legacy environment 64 that includes files, programs and data.

In order for the user or student to be able to access and communicate with the Mindshare™ System 10 via the Internet (web), the computing infrastructure 40 includes a graphical user interface (GUI) 58 that is preferably Java enabled. Additionally, a secure supplier profile interface 60 is provided that allows an educational/content material supplier to securely send, rescind, and/or edit any educational/content material in accordance with the established procedure for review and/or inclusion of the educational/content material into the Mindshare™ system. As well, the computing infrastructure 40 includes a secure personalized web interface 62 for allowing a user secure access to information retained by the Mindshare™ system.

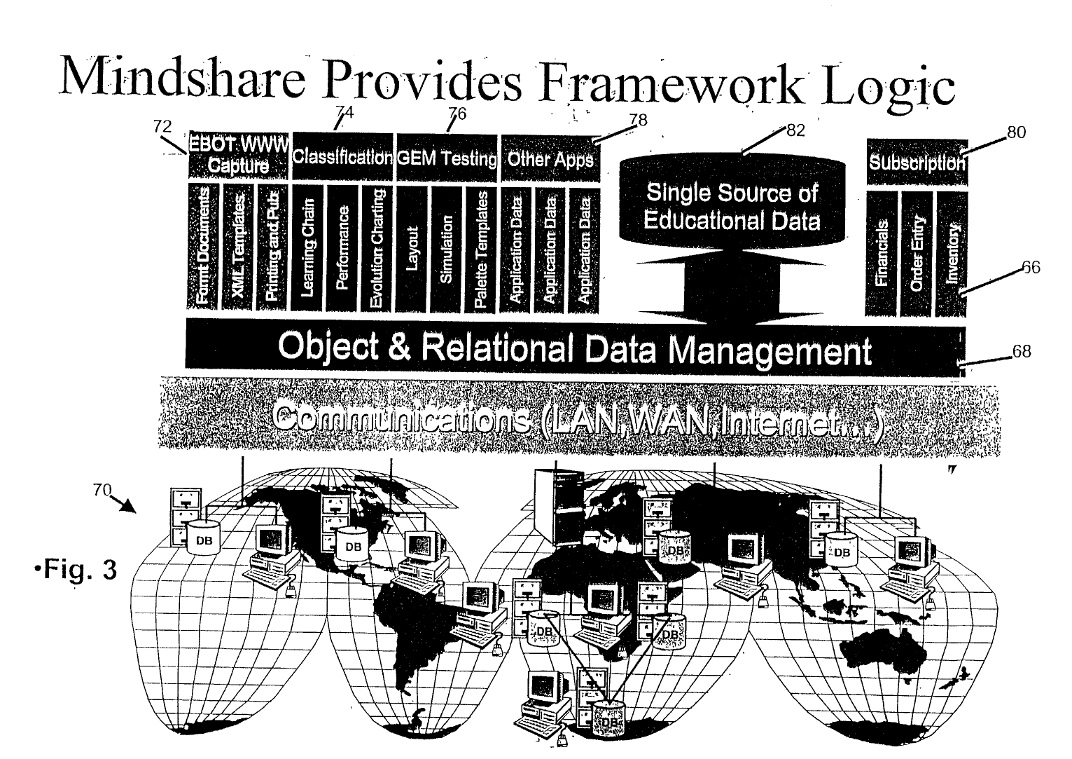

With additional reference to FIG. 3, the Mindshare™ system 10 (see FIG. 1) includes framework logic to pull together the various aspects of the object and relational data management system 66 of Mindshare™. As indicated above, the Mindshare™ system 10 is coupled to the world's web enabled devices (collectively 70) via various communication methods and/or systems 68. Of course, Mindshare™ includes the means necessary to implement the communication types and configurations depicted.

In order to create the single source of educational data 82 that makes up tasks, some of which are depicted in FIG. 3. Ebot Internet capture 72 is implemented through the object and relational data management section 66. The ebot capture 72 includes form documents, XML templates, and printing and publication. As well, the object and relational data management system 66 provides classification 74 of the various educational/IC material from ebot, third party suppliers and the like. Such classification includes the learning chain, performance, and evolution charting.

In accordance with one aspect, the object and relational data management section 66 performs GEM testing 76 which includes layout, simulation where necessary, and generation of the palette/templates that are used to select appropriate educational/IC material that is stored in the Mindshare™ system 10 and/or available via the various multitude of pages of the internet. The object and relational data management system 66 also includes any other necessary applications 78 (including application data) to implement the various aspects of the Mindshare™ system described herein.

It is contemplated that various institutions, companies, and individuals will want to access and use the educational system taught herein as implemented by Mindshare™. The Mindshare™ program contemplates profitability through various means such as tuition, third party submission of educational/IC material and payment for posting/use, advertising, and the like. In the case of tuition, those people, companies and the like who desire to use the Mindshare™ system will pay tuition and/or a subscription 80 for such use. The object and relational data management system 66 includes the ability to track subscription information such as financials, order entry, and inventory of educational/IC material.

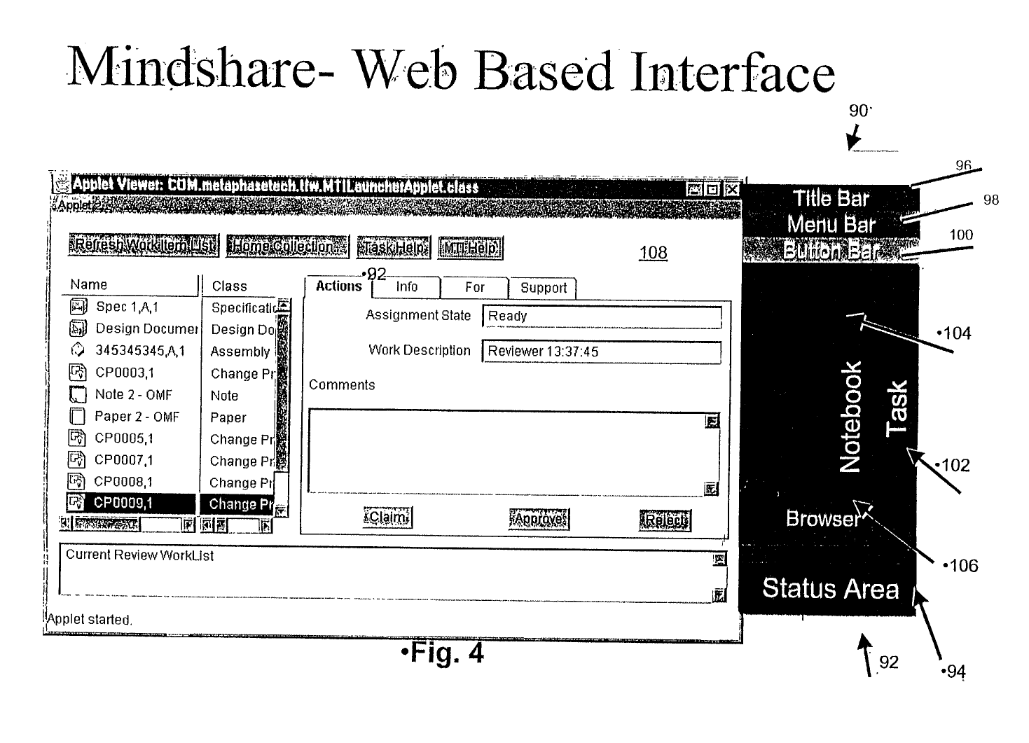

Typically, it is only necessary for the web-enabled device to have a standard Internet browser or similar program in order to avail the user/student of the education provided by the Mindshare™ system. With reference to FIG. 4, an exemplary GUI 90 for access to, implementation and use of the Mindshare™ system is shown. It should be appreciated that since the GUI 90 is only exemplary, other styles/configurations may be used. The GUI 90 includes a mode area 92 that is used to select various GUI modes. These modes may include a status area 94, a title bar area 96, a menu bar area 98, a button bar area 100, a task area 102, notebook area 104 and a browser area 104. In addition, the GUI 90 includes a viewing/working area 108 in which the various educational/IC material is presented, tests are taken, scores/progress is posted, and the like.

The GUI 90 may also be used to initiate the system 10 into gathering information or content from the Internet for pushing or providing the content to the user. As such, the GUI 90 may include a semantic engine to aid the system 10 in retrieving content from the Internet, filtering the content according to the user's profile and provide the content to the user. As well, the system 10 may reformat the content as per the user's hardware profile in order that the filtered or edited content gathered from the Internet may be displayed on the user's system.

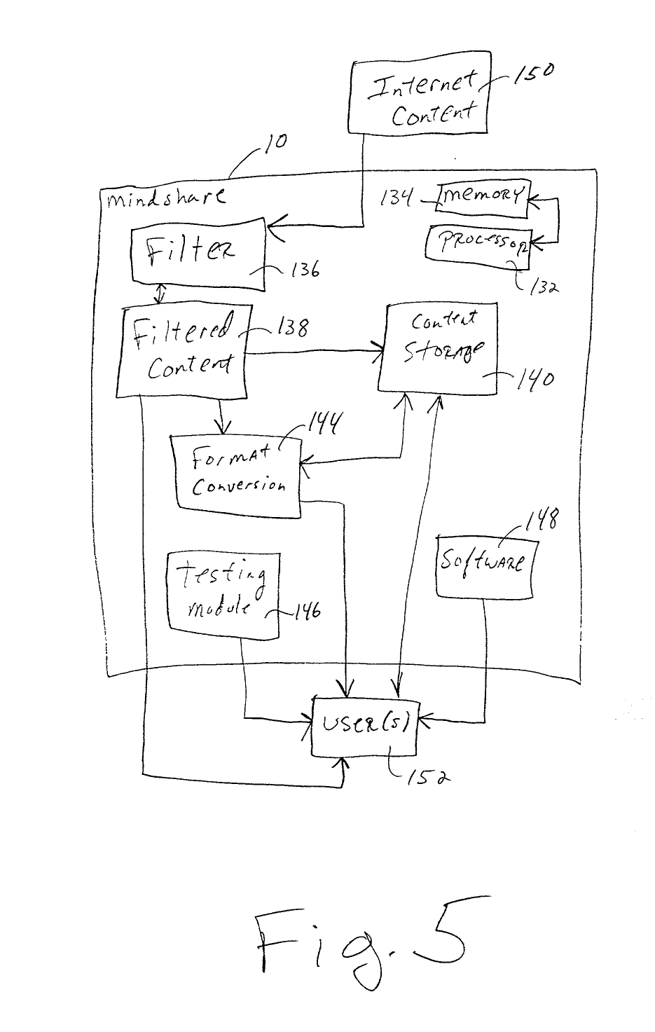

Referring to FIG. 5, a simplified block diagram of the system 10 is shown in accordance with an aspect of the subject invention. The system 10 includes a processor 132 and memory 134 that stores or contains program instructions to run or operate the subject invention in the manner set forth herein. While not shown, the processor 132 is in communication with the various components or modules of the system 10. The system 10 includes a filter 136 that receives Internet content 150. The filter 136 edits and/or parses the content according to the user's profile and/or the user's level within a learning chain of an educational plan (attainment level) or the user's current knowledge with respect to a chosen subject. This becomes the filtered content 138. The filtered content 138 may be stored in a content storage device 140 for later use. Later use may constitute representing the content to the user if necessary, either in the same or different format, typically as a result of test results with respect to the content. Later use may constitute providing the content to another user. Both conditions are represented by the line to the user 152.

The filtered content 138 may be directly provided to the user (as represented by the line connecting the filtered content 138 to the user 152) or may be converted into another format for presentation or providing to the user 152. Format conversion 144 is operative to take the format of the content and convert it to another form. The converted form content from the format conversion 144 may be stored in the content storage 140 or provided directly to the user 152. The system 10 also includes a testing module 146 that is operative to provide testing of the subjects provided to the user. Additionally, the system 10 includes software 148 that may be provided to the user to allow the subject invention to operate.

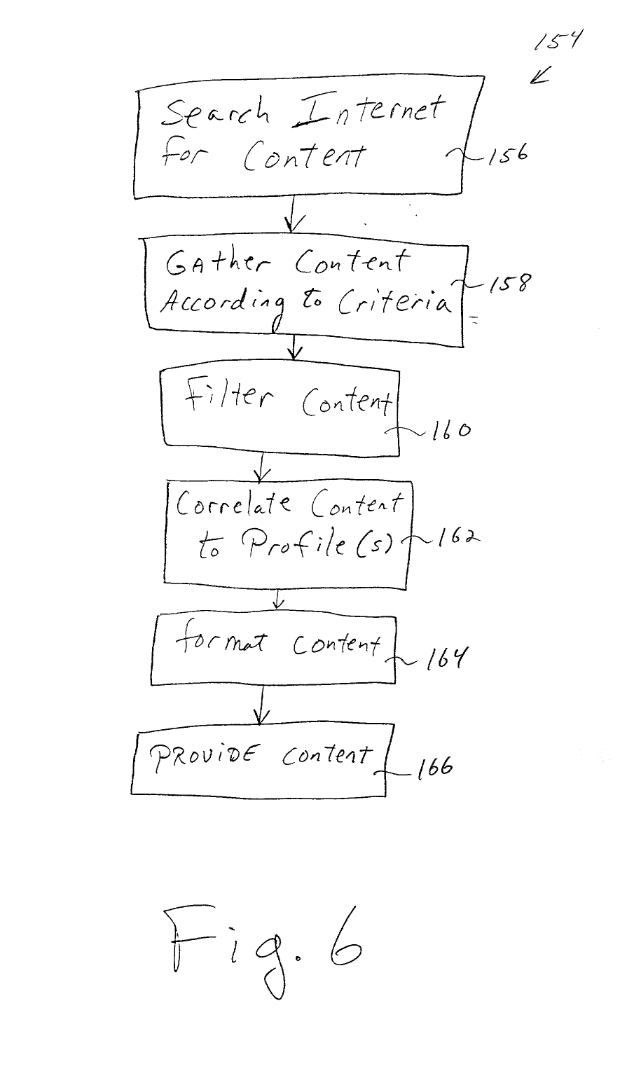

Referring to FIG. 6, there is depicted a flow chart, generally designated 154, of an exemplary manner of an aspect of operation of the subject invention. Initially, in step 156, the system 10 searches the Internet for content. As explained above, content may be selected by the system 10 in response to an educational plan with regard to a particular subject, or may be selected by the user preferably with the aid of the GUI 90. In step 158, content is gathered by the system 10 according to various criteria such as the user's learning profile and/or hardware profile and subject matter. Content format may be a criterion. In step 160, the system 10 filters the content appropriately with regard to the various criteria. In step 162, the content is correlated to the profile(s) of the user. In step 164 the content is formatted accordingly if necessary. Thereafter, in step 166, the content is provided to the user preferably via the Internet.

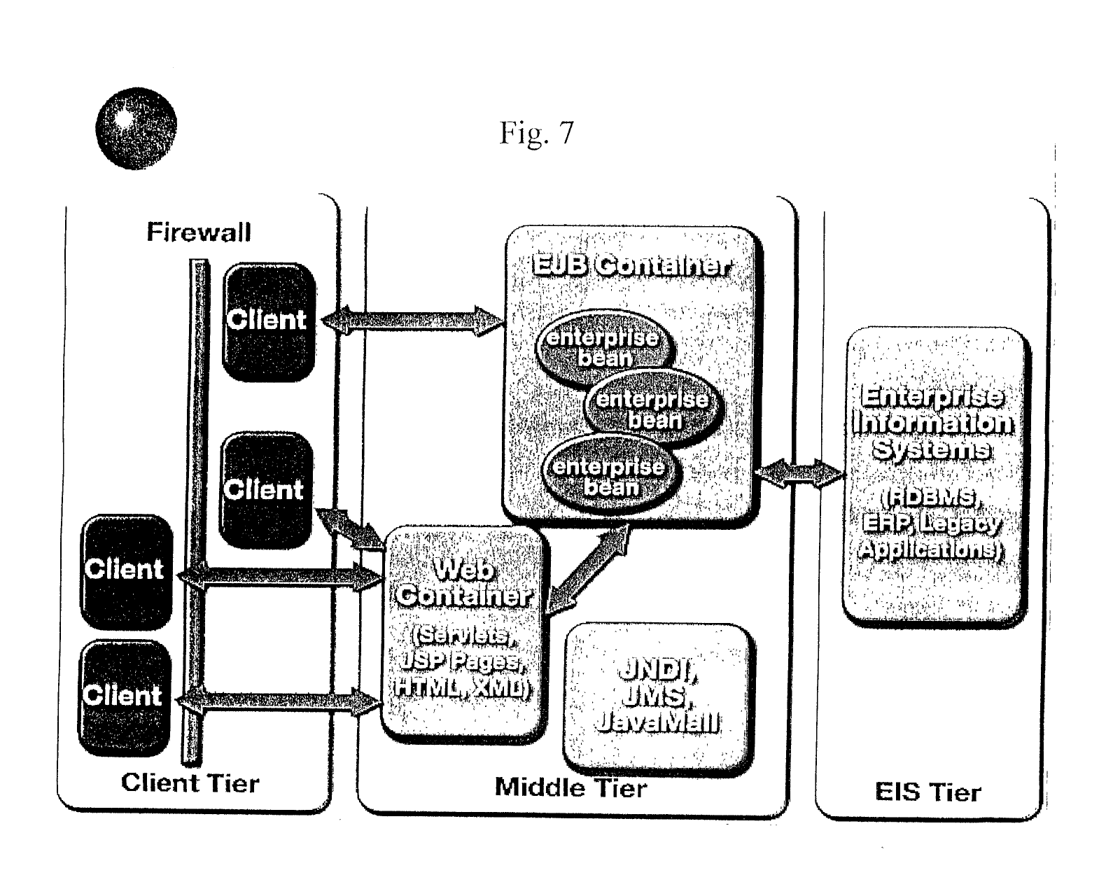

Referring to FIG. 7, the enterprise may consist of the client tier, the middle tier, and the EIS (Enterprise Information Systems) tier. The system 10 may be comprised of the middle tier and the EIS tier. The client tier represents the various users of the system 10. The EIS tier is the top tier that contains or is operative to provide the various information systems architecture or programming. The EIS tier interfaces with the middle tier that consists of an EJB (Enterprise Java Bean) container, a web container and a JNDI, JMS and Javamail architecture module. The EJB container contains a plurality of enterprise beans that interface with a client, the enterprise information systems, and the web container. The web container includes servlets, JSP pages, HTML, and XML programs/programming. The clients may interface with the web container if appropriate.

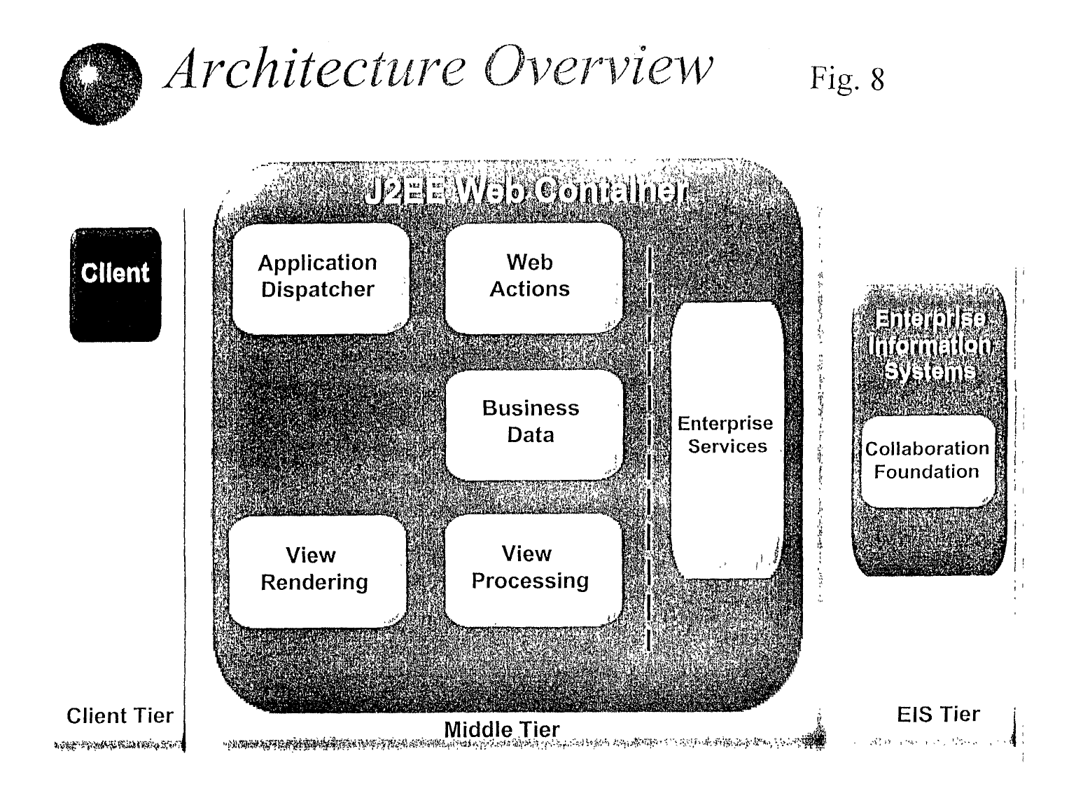

In FIG. 8, an exemplary web container is depicted. The web container may be a Java 2EE container that includes an application dispatcher module, a view rendering module, a web actions module, a business data module, a view processing module, and an enterprise services module. These modules interact to provide a client with content as provided herein. The J2EE web container also interacts with the EIS, again to provide content to user.

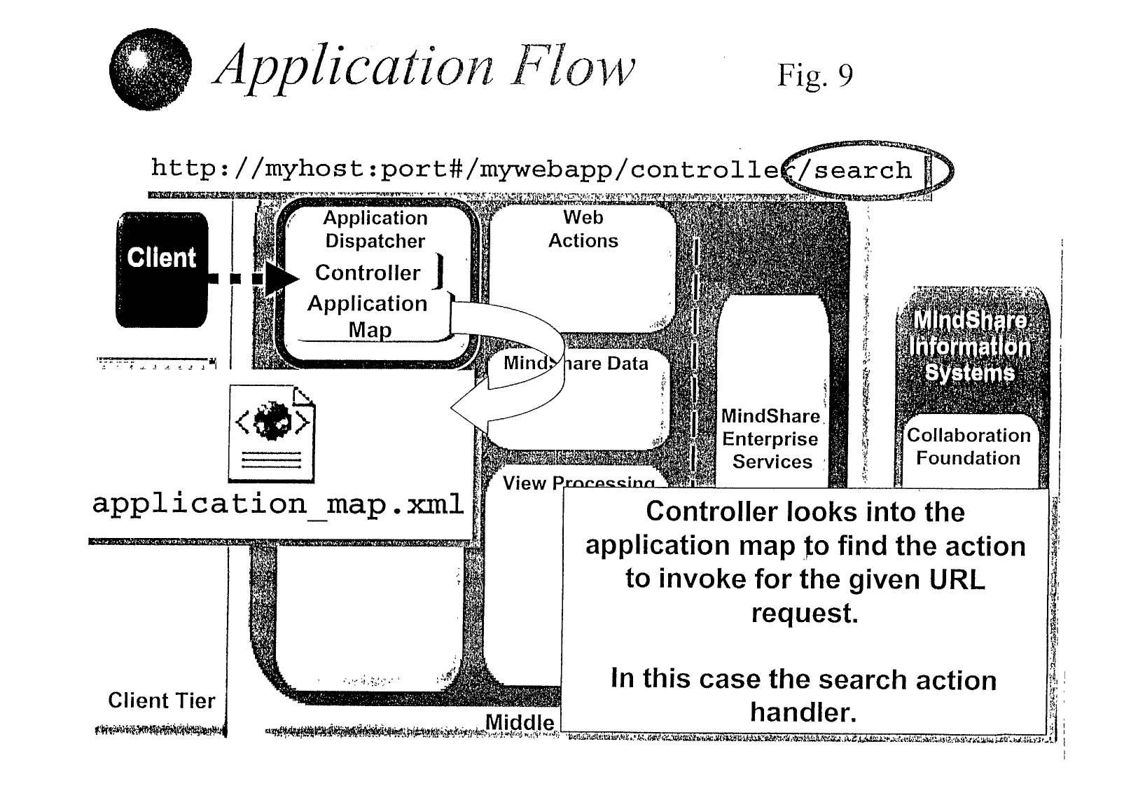

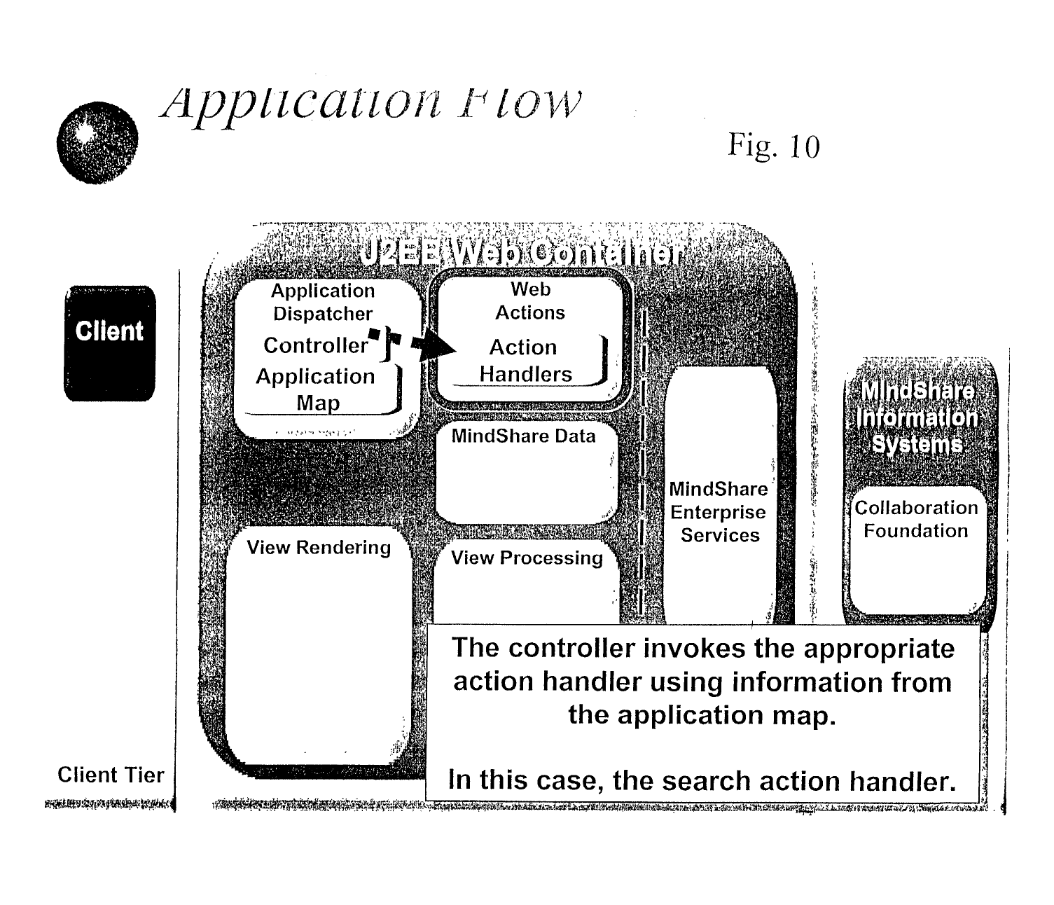

Referring to FIGS. 9-16, there is depicted an exemplary manner of operation (application flow) with respect to the exemplary embodiment of the enterprise/system 10 depicted in FIGS. 7 and 8. In FIG. 9, the system 10 controller looks into the application map to find an action to invoke for a given URL request from the client. In this case, the application map (application_map.xml) finds the search action handler to invoke. It should be appreciated that the exemplary manner of operation may be extrapolated to a content search and retrieval for a subject. In FIG. 10, the controller, having found the requisite action, invokes the appropriate action handler using information from the application map. In this case, the appropriate action handler is the search action handler.

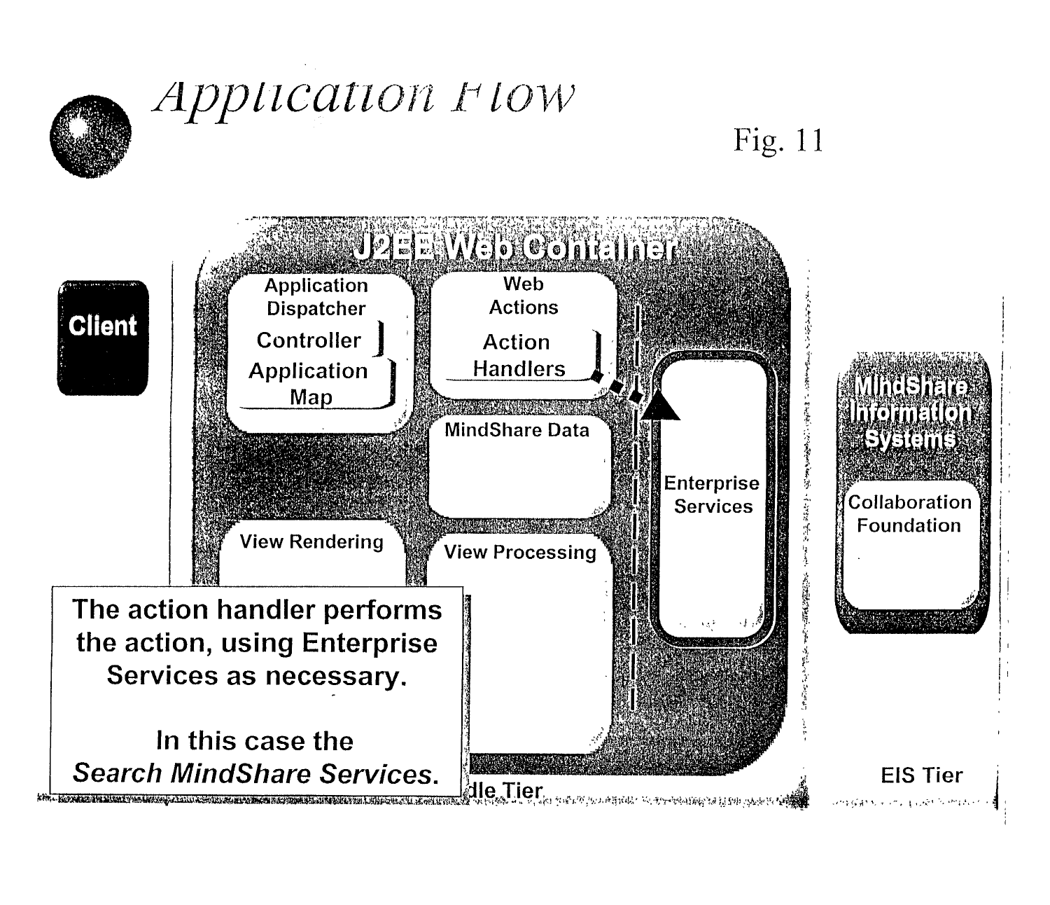

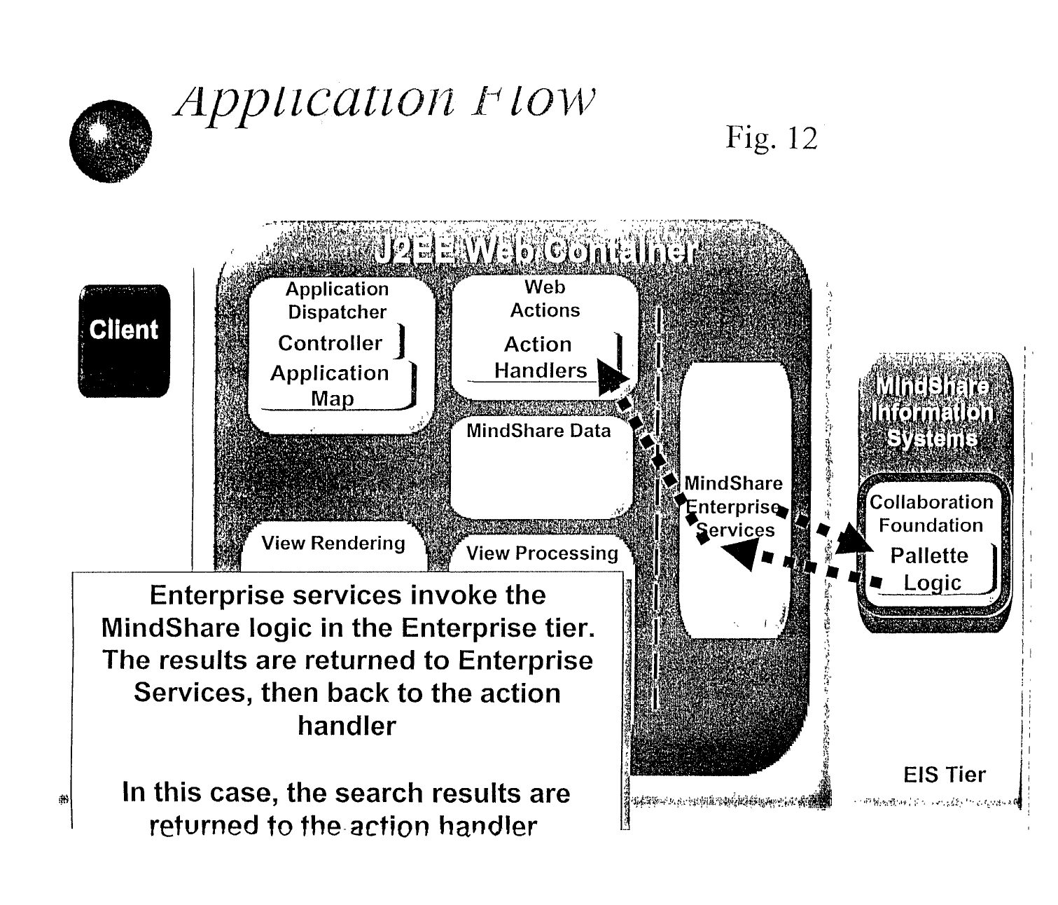

In FIG. 11, action handler performs the particular action requested, using the enterprise services as necessary. In this case, the enterprise service is the Mindshare system. The enterprise service invokes the Mindshare logic in the enterprise tier as depicted in FIG. 12. The Mindshare information systems utilize profile or palette logic to perform a search, the results of which are returned to the enterprise services, then back to the action handler. In the present instance, the search results are returned to the action handler.

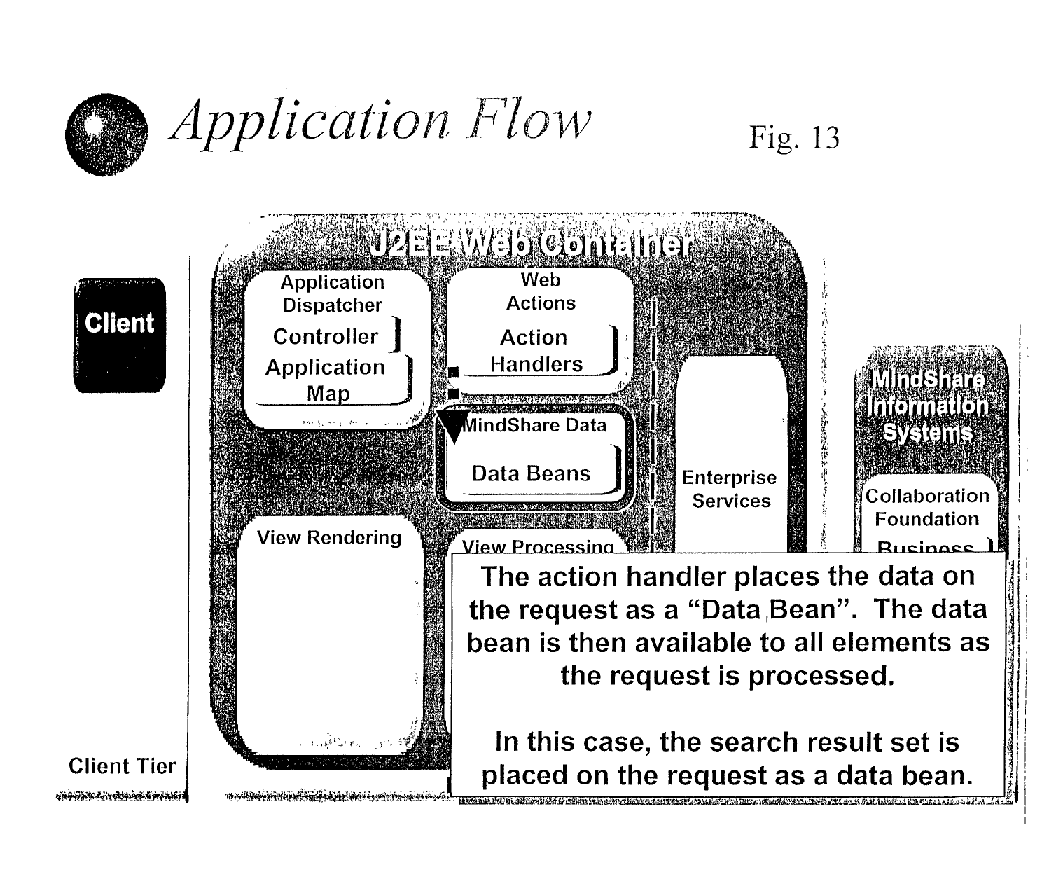

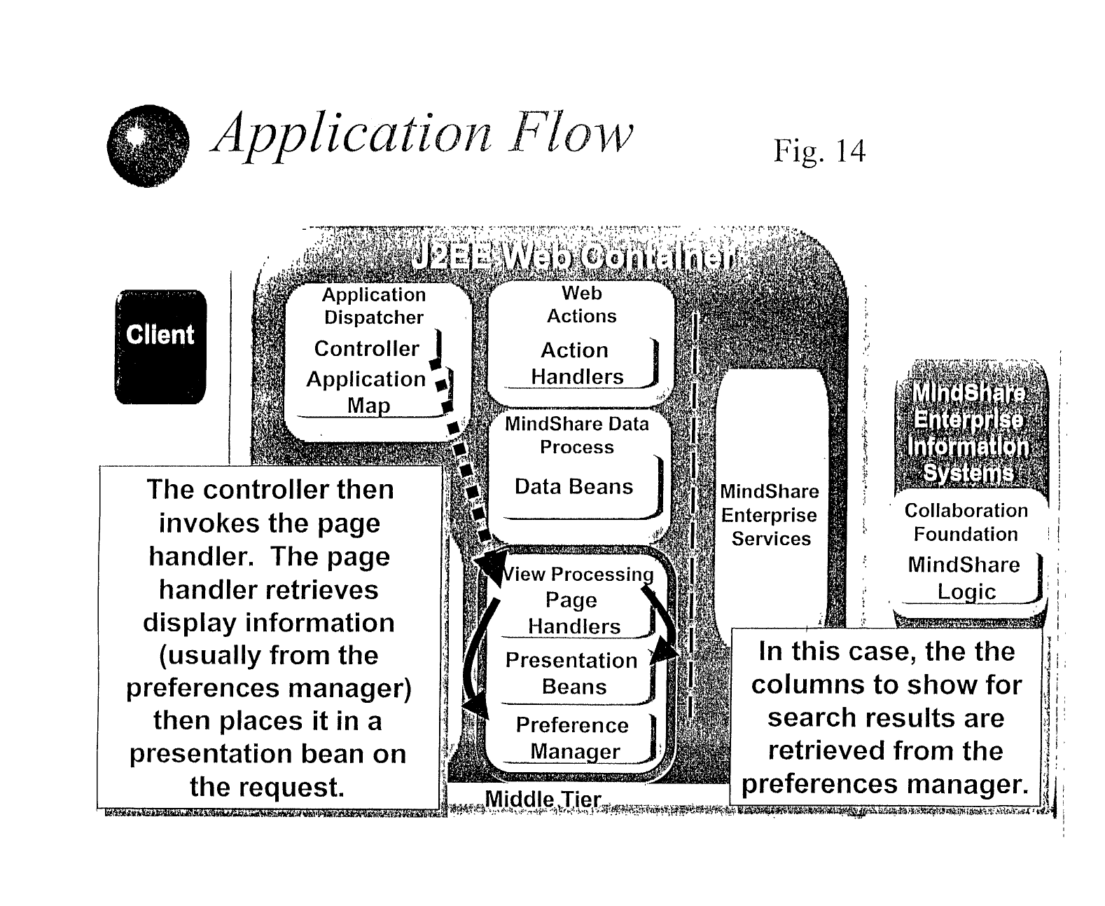

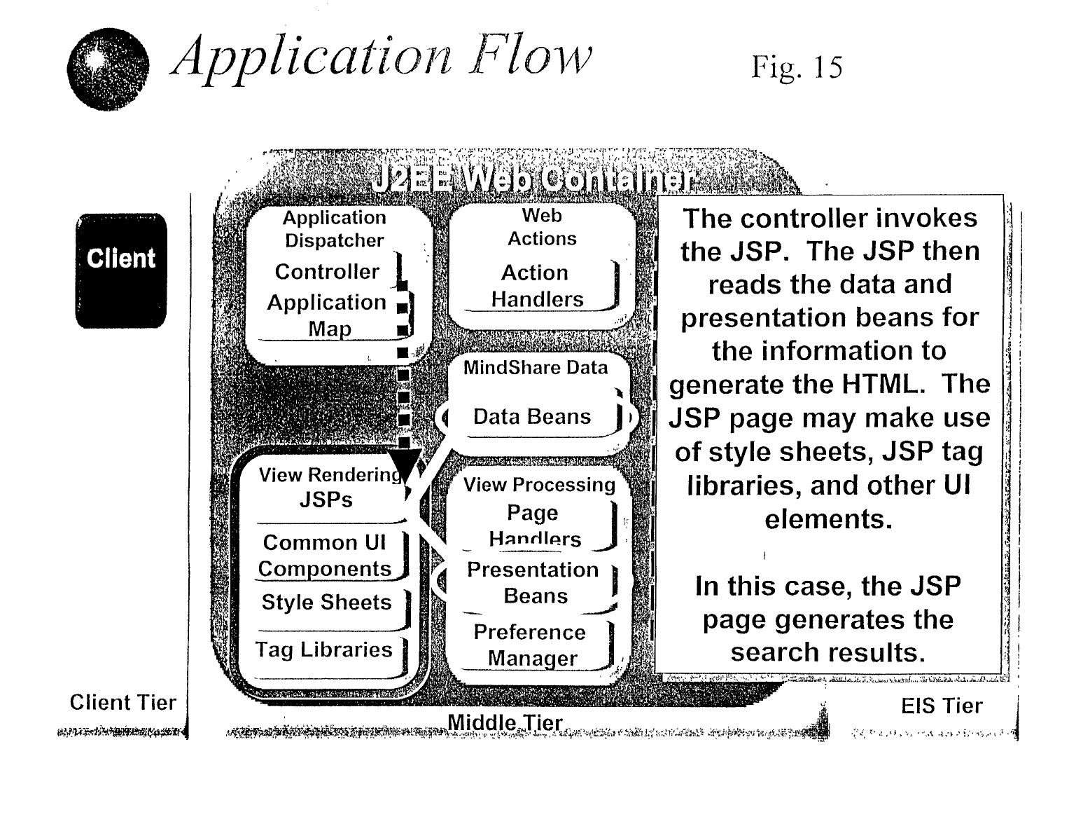

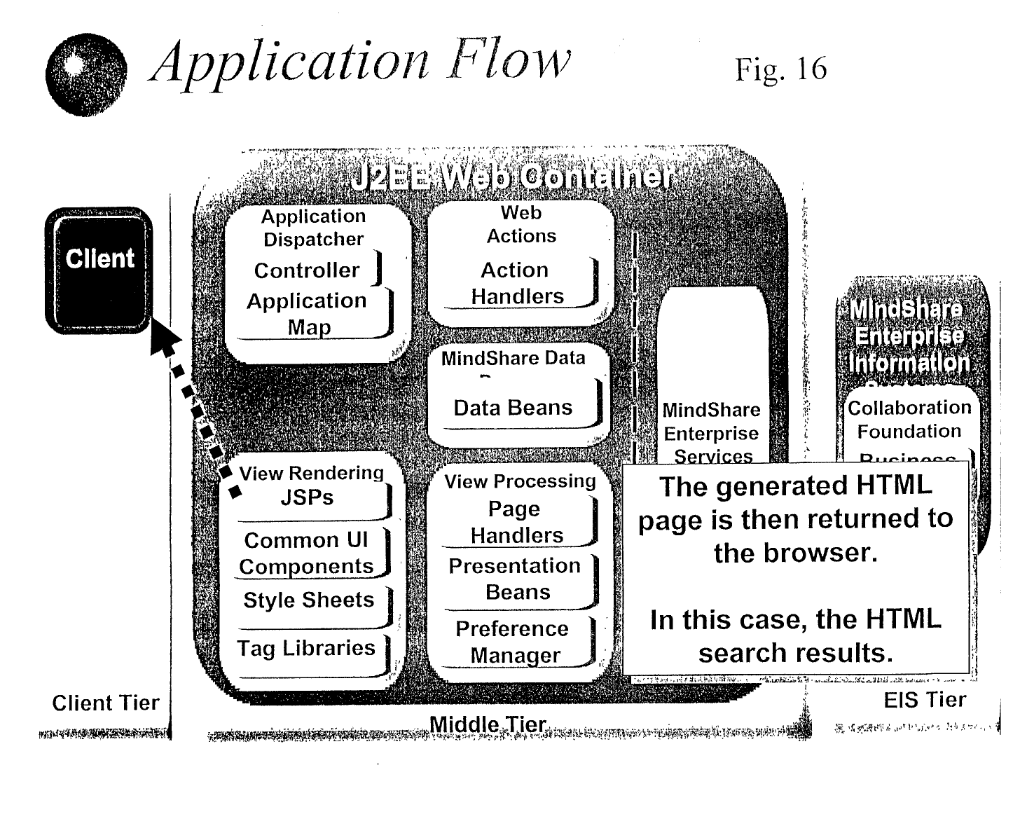

In FIG. 13, the action handler places the data on the request as a “data bean.” The data bean is then available to all elements as the request is processed. In the present case, the search result set (content) is placed on the request as a data bean. The controller then invokes the page handler as illustrated in FIG. 14. The page handler retrieves display information (usually from a preferences manager) then places the display information in a presentation bean on the request. In the present instance, the columns various columns to show for the search results are retrieved from the preferences manager. In FIG. 15, the controller invokes the JSP. The JSP then reads the data and presentation beans for the information to generate the HTML (or other format as appropriate for the user). The JSP page may make use of style sheets, JSP tag libraries, and other UI elements. In this case, the JSP page generates the search results. Lastly, in FIG. 16, generated HTML page is then returned to the browser of the client (user). In the present case, the HTML page is the HTML search results.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the claims hereafter.

What is claimed is:

1. A method of providing information to a user comprising the steps of:
gathering content from the Internet based on a user profile;
filtering the gathered content to obtain learning content; and
providing the learning content to the user via the Internet.

2. The method of claim 1, further comprising the step of formatting the learning content based on a hardware profile of the user before providing the learning content.

3. The method of claim 1, wherein the step of gathering content includes the step of determining position of the user on a learning chain relative to a subject matter.

4. The method of claim 1, further comprising the step of:
allowing user input on a particular subject before gathering content from the Internet.

5. The method of claim 4, further comprising the step of:
providing a graphical user interface that allows user input on a particular subject.

6. The method of claim 1, further comprising the step of:
testing the user on the provided learning content.

7. The method of claim 1, wherein the step of filtering includes the step of:
analyzing the gathered content against the user profile.

8. A method of teaching comprising the steps of:
obtaining a learning profile for a user;
storing the learning profile;
gathering content from the Internet pertaining to a subject in response to a user request;
filtering the gathered content based on the learning profile; and
providing the filtered content to the user via the Internet.

9. The method of claim 8, wherein further comprising the step of formatting the learning content based on a hardware profile of the user before providing the learning content.

10. The method of claim 8, wherein the step of gathering content includes the step of determining position of the user on a learning chain relative to the subject.

11. The method of claim 8, further comprising the step of:
allowing user input on the subject before gathering content from the Internet.

12. The method of claim 11, further comprising the step of:
providing a graphical user interface to the user that allows user input on the subject.

13. The method of claim 8, further comprising the step of:
testing the user on the provided learning content.

14. The method of claim 8, wherein the step of filtering includes the step of:
analyzing the gathered content against the learning profile.

15. A system for providing information to a user comprising:
a processor;
memory in communication with said processor and containing a plurality of program instructions which, when executed by said processor, causes the system to:
(i) gathering content from the Internet based on a user profile;
(ii) filtering the gathered content to obtain learning content; and
(iii) providing the learning content to the user via the Internet.

16. The system of claim 15, wherein the memory has program instructions which, when executed by said processor, causes the system further to:
format the learning content based on a hardware profile of the user before providing the learning content.

17. The system of claim 15, wherein the memory has program instructions which, when executed by said processor, causes the system further to:
determine position of the user on a learning chain relative to a subject matter.

18. The system of claim 15, wherein the memory has program instructions which, when executed by said processor, causes the system further to:
allow user input on a particular subject before gathering content from the Internet via a graphical user interface that allows user input on the subject.

19. The system of claim 15, wherein the memory has program instructions which, when executed by said processor, causes the system further to:
test the user on the provided learning content.

20. The system of claim 15, wherein filtering includes analyzing the gathered content against the user profile.
